(19) United States
(12) Patent Application Publication
(10) Pub. No.: US 2009/0150061 A1
(43) Pub. Date: Jun. 11, 2009

(54) HUD VEHICLE NAVIGATION SYSTEM

(75) Inventors: YU-HSIN CHEN, Tu-Cheng (TW); JUNG-CHIEH WONG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/170,539

(22) Filed: Jul. 10, 2008

(30) Foreign Application Priority Data
Dec. 7, 2007 (CN) 200710202929.2

(51) Int. Cl. G01C 21/26

(52) U.S. Cl. 701/200

(57) ABSTRACT

A HUD vehicle navigation system includes a portable electronic device (10) and a combiner (20). The portable electronic device includes a navigation module (151), a converting module (153), and a display module (131). The navigation module is configured to receive and transmit navigation information. The converting module electronically connects to the navigation module, and receives and converts the navigation information into mirror-image navigation information. The display module electronically connects to the navigation module and the converting module to alternatively display the navigation information or the mirror-image navigation information. The combiner is attached on an windshield of a vehicle, and is configured to reflect the mirror-image navigation information projected from the display module for view by the vehicle operator while allowing a clear view of the traffic conditions in front of the vehicle.

### BACKGROUND

1. Technical Field

The present invention relates generally to heads up display (HUD) vehicle navigation systems for providing vehicle operators directions to a specific destination, and particularly to a HUD vehicle navigation system that receives routing information from portable electronic devices, such as mobile phones and personal digital assistants.

2. Description of the Related Art

Conventionally, when people visit an unfamiliar area, they normally reach their destination by relying on an atlas or some kind of guidebook or directory for directions. However, using an atlas or guidebook is not convenient for users. Therefore, vehicle navigation systems are being provided to provide navigation information to vehicle operators.

Traditional vehicle navigation systems utilize an on-board route calculator and map data base or, alternatively, utilize a remote navigation server connected on a real-time basis to the vehicle by a wireless communication channel. Such vehicle navigation systems also feature a dedicated full-screen display displaying a route map to a desired destination. These known vehicle navigation systems are complex and expensive and therefore are usually available as an option only in high-end luxury vehicles.

In another aspect, with the development of wireless communication technology, portable electronic devices, such as mobile phones, personal digital assistants (PDAs), palm computers, and the like, are constructed to have multiple functions, e.g. navigation or global position system (GPS) function, to satisfy the needs of users. Hence, vehicle operators can use the navigation/GPS function from a portable electronic device, when vehicles do not incorporate a navigation system.

In use of the navigation system or the mobile phone having a navigation function, typically, the display of a vehicle navigation system or the mobile phone is placed on a dashboard of the vehicle. The operator of a vehicle has to glance downward to the vehicle dashboard and away from the viewing area in front of the vehicle. It is unsafe for the vehicle operator to take his/her eyes off the road which increases the chances of having a traffic accident.

Therefore, an improved vehicle navigation system is desired in order to overcome the above-described problems.

### BRIEF DESCRIPTION OF THE DRAWINGS

Many aspects of the present HUD vehicle navigation system can be better understood with reference to the following drawings. The components in the drawings are not necessarily drawn to scale, the emphasis instead being placed upon clearly illustrating the principles of the present HUD vehicle navigation system and its potential applications. Moreover, in the drawings, like reference numerals designate corresponding parts throughout the several views.

FIG. 1 shows a schematic view of a HUD vehicle navigation system according to an exemplary embodiment.

### DETAILED DESCRIPTION OF THE PREFERRED EMBODIMENTS

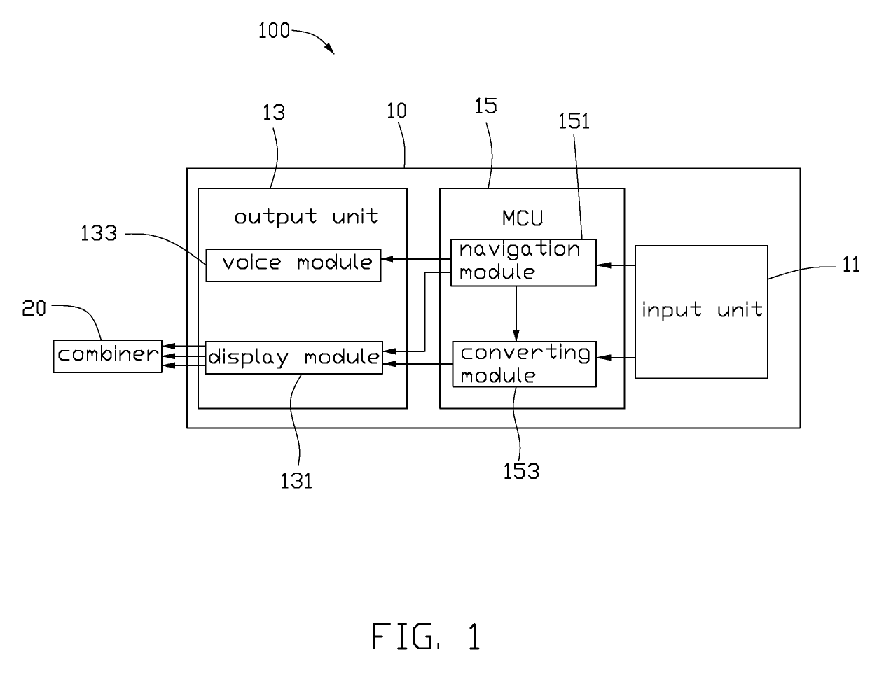

Referring to FIG. 1, a HUD vehicle navigation system 100 according to an exemplary embodiment is shown. The HUD vehicle navigation system 100 includes a portable electronic device 10, and a combiner 20. The portable electronic device 10 can include a projector (not shown) that projects navigation information on the combiner 20. The combiner 20 reflects the navigation information projected thereon for view by the vehicle operator while allowing a clear view of the traffic conditions in front of the vehicle.

The portable electronic device 10 can be but is not limited to a mobile phone, a personal digital assistant (PDA), etc. The portable electronic device 10 includes an input unit 11, an output unit 13, and a microcontroller unit (MCU) 15.

The input unit 11 generally refers to a keypad or a touch-screen (schematically shown) used to input settings, i.e. information identifying the desired destination, from a vehicle operator, and transmit commands in association with the settings to the MCU 15 for processing. The input unit 11 further includes a mode switch key (not shown). The mode switch key is configured to switch between different modes of the portable electronic device 10. The mode switch process will be described in detail later.

The output unit 13 generally includes a display module 131 and a voice module 133. The display module 131 generally refers to a liquid crystal display (LCD) for displaying text and graphic information, i.e., navigation information such as a map, to the vehicle operator, or projecting information on the combiner 20. The voice module 133 generally refers to a speaker module for delivering audio information, i.e. audio navigation information, to the vehicle operator.

The MCU 15 essentially includes a navigation module 151, and a converting module 153. The navigation module 151 electronically connects with the input unit 11, the display module 131, the voice module 133 of the output unit 13, and the converting module 153. The navigation module 151 can receive real-time navigation information from a remote navigation server using wireless communication, or from a navigation database stored in the portable electronic device 100. When the navigation module 151 receives a command in association with an address of a desired destination, it searches and captures corresponding navigation information from the remote navigation server or the navigation database, and then transmits navigation signals to the voice module 133, and the display module 131. Alternatively, the navigation module 151 can transmit the navigation signals to the converting module 153, which is configured to convert navigation signals transmitted from the navigation module 151 into mirror-image navigation signals and transmit the converted signals, i.e. the mirror-image navigation signals, to the display module 131. The converting module 153 electronically connects with the input unit 11, the navigation module 151, and the display module 131, and is configured to convert navigation signals transmitted from the navigation module 151 into mirror-image navigation signals used when the navigation information is to be projected onto the combiner 20 rather than displayed on an LCD. When the mirror-image navigation signals are projected onto the combiner 20, the displayed navigation information is reversely arranged/oriented from right and left relative to the displayed navigation information corresponding to the navigation signals. Therefore, when the navigation information is reflected back to the vehicle operator, the information is properly oriented.

The portable electronic device 100 has a normal mode, and a vehicle navigation mode. The mode switch key is used to switch the portable electronic device 100 between the normal mode and the vehicle navigation mode. In the normal mode, the LCD of the display module 131 receives and directly displays the navigation signals received from the MCU 151. In the vehicle navigation mode, mirror-image navigation signals transmitted from the converting module 153 are projected onto the combiner 20.

The combiner 20 is advantageously attached to a windshield of the vehicle. The combiner 20 receives and reflects light of the mirror-image navigation information projected by the display module 131 in front of the vehicle operator's field of view, while allowing the driver to see outside traffic situations in front of the vehicle. The combiner 20 mounted to the windshield is made of reflective transparent optical material. The combiner 20 can be further made with reflective transparent optical material that can enlarge the navigation information to facilitate vehicle operator observing the navigation information. After the mirror-image navigation information is reflected by the combiner 20, the vehicle operator views correctly oriented navigation information.

In use, the mode switch key is used by the vehicle operator to switch between the normal mode and the navigation mode of the portable electronic device 10. Then, the vehicle operator inputs the identifying information of a desired destination through the input unit 11 to receive desired navigation information, and places the portable electronic device 10 in front of the combiner 20 attached on the windshield of the vehicle. The voice module 133 delivers voice navigation information to the vehicle operator. The display module 131 projects mirror-image navigation information on the combiner 20. The combiner 20 reflects the mirror-image navigation information into the vehicle operator's field of view. Therefore, the vehicle operator can see the navigation information while still having a clear view of the traffic conditions in front of the vehicle. Thus, the vehicle operator using the vehicle equipped with the HUD vehicle navigation system can safely receive navigation information, either audibly or visually, without taking his/her eyes off the road.

It is to be understood, that part of the vehicle windshield can be made of reflective transparent optical material to function as a combiner 20.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A HUD vehicle navigation system comprising:
a portable electronic device, comprising:
a navigation module configured to receive and transmit navigation information;
a converting module electronically connected to the navigation module, the converting module receiving the navigation information and converting the navigation information into mirror-image navigation information; and
a display module electronically connected to the navigation module and the converting module to alternatively display the navigation information or the mirror-image navigation information; and
a combiner attached on a windshield of a vehicle, and being configured to reflect the mirror-image navigation information projected thereon for view by the vehicle operator while allowing a clear view of the traffic conditions in front of the vehicle.

2. The HUD vehicle navigation system as claimed in claim 1, wherein the portable electronic device further comprises a voice module electronically connecting with the navigation module to receive and deliver audio navigation information.

3. The HUD vehicle navigation system as claimed in claim 2, wherein the audio module is a speaker module of the portable electronic device.

4. The HUD vehicle navigation system as claimed in claim 1, wherein the portable electronic device further comprises an input unit configured to receive inputs of identifying information for a desired destination and a mode switch signal, and transmit commands associated with the inputs to the navigation module and the converting module, to control the navigation module to receive desired navigation information and the display module to alternatively display navigation information and the mirror-image navigation information.

5. The HUD vehicle navigation system as claimed in claim 4, wherein the input unit is a keypad or a touch-controlled pad of the portable electronic device.

6. The HUD vehicle navigation system as claimed in claim 1, wherein the combiner is made of reflective transparent optical material.

7. The HUD vehicle navigation system as claimed in claim 6, wherein the combiner can enlarge images projected thereon.

8. The HUD vehicle navigation system as claimed in claim 1, wherein the navigation module receives navigation information from a remote navigation server using wireless communication.

9. The HUD vehicle navigation system as claimed in claim 1, wherein the navigation module receives navigation information from a navigation database stored in the portable electronic device.
